(19) United States
(12) Patent Application Publication
(10) Pub. No.: US 2024/0423250 A1
(43) Pub. Date: Dec. 26, 2024

(54) SYSTEM AND METHOD FOR MODULAR DEHYDRATION WITH HEATING AND COOLING MODULES

(71) Applicant: Timothy Childs, San Francisco, CA (US)

(72) Inventor: Timothy Childs, San Francisco, CA (US)

(21) Appl. No.: 18/668,068

(22) Filed: May 17, 2024

Related U.S. Application Data
(60) Provisional application No. 63/467,579, filed on May 18, 2023.

(51) Int. Cl. A23L 3/54; F26B 21/08

(52) U.S. Cl. CPC A23L 3/54; F26B 21/08

(57) ABSTRACT

The present invention pertains to a selectively automated airflow system that quickly removes built up heat and moisture by introducing processed (temperature and humidity controlled) or ambient air, while removing heat accumulation found on the products and in the surrounding space during processing to provide higher rates of dehydration with lower food structure degradation and better volatile retention. All of this is completed while using less energy during processing than previous systems. The present system includes both asymmetric and symmetric perforations in air ducting that have been created by computer assisted guidance and can be further customized for processing specific agricultural, food and industrial ingredient inputs.

### CROSS REFERENCE TO RELATED APPLICATIONS

This application claims the benefit of U.S. Provisional Patent Application Ser. No. 63/467,579 filed on May 18, 2023, the contents of which are incorporated herein by reference.

### BACKGROUND OF THE INVENTION

The present invention is directed to a system and method for sequential infrared (“IR”) dry blanching/dehydration (hereinafter referred to as “SAUNA” or “SAUNAflow”). Prior similar systems assumed that no special system of heat dissipation was required given the short processing times characteristic of IR blanching. However previous systems failed to address the fact that heat pools in and around the product material during SAUNA processing.

The present invention provides a novel computer-assisted air flow modeled system that brings in cool, room temperature, or processed air and or humidity-controlled air dissipates heat and moisture more effectively. The present system has proven to be a more efficient method of dehydration that retains potentially useful volatile flavor and odor compounds and may retain sensitive nutrients better than previous systems.

Current systems do not utilize efficient computer-assisted airflow pathways that dissipate heat and moisture while also retaining the benefits of compounds from sensitive nutrients, including volatile compounds in extracts for live feed.

To overcome these challenges, the present invention introduces a novel computer-assisted airflow modeled system designed to enhance heat and moisture dissipation efficiency. This system integrates the controlled introduction of cool, room temperature, or processed air, along with humidity control, to effectively dissipate heat and moisture during the SAUNA process. By leveraging advanced modeling techniques, the airflow system optimizes airflow patterns to minimize heat pooling and promote uniform drying, thereby improving dehydration outcomes.

An advantageous aspect of the present system is its ability to execute a dehydration operation while retaining potentially beneficial volatile flavor, odor, and chemical compounds. Previous systems compromise the integrity of these compounds due to inefficient heat dissipation. Moreover, the system's enhanced moisture removal capabilities enable retention of nutrients and volatile compounds, thus enhancing the nutritional value of the dehydrated products.

Overall, the present invention provides an improvement in the field of dehydration technologies, which result in an improvement in product quality and higher yielding nutrient retention.

### SUMMARY OF THE INVENTION

The present invention pertains to a selectively automated airflow system that quickly removes built up heat and moisture by introducing cool, room temperature, or processed air and/or dry air while removing heat accumulation found on the products and in the surrounding space during processing to provide higher rates of dehydration and hornification with better volatile retention and in the case when followed by industrial drying technologies such as freeze drying then the process will additionally lower food structure degradation. All of this is completed while using less energy during processing than previous systems. The present system includes both asymmetric and symmetric perforations in air ducting and interior baffle that have been created by computer assisted guidance and can be further customized for processing specific agricultural and food ingredient inputs.

SAUNAflow allows for greater IR (either gas or electric) penetration and exposure by simultaneously blowing in processed (temperature and humidity controlled) or ambient air while suctioning or blowing away any excess heat building on the product and inside the heating chamber. Airflow introduction and heat removal efficiency can be amplified through a venturi effect. One side allows for processed (temperature and humidity controlled) or ambient airflow entering the top or bottom of the material heating zone while the other side actively pulls the heat away evenly and efficiently. This process not only increases dehydration efficiency (and other SAUNA properties), but it can also help retain volatile compounds, making this a novel and more effective form of SAUNA. For example, we have demonstrated in practice to capture all the water vapor removed from the product in dehydration (SAUNACapture) via condensing through a radiative chiller or a frozen plate, and then further processing the water through vacuum distillation to further remove the captured volatile compounds such as flavors and fragrances carried off by moisture from the dehydrated material.

SAUNAflow is a modular dehydration system. Heating modules can be combined with passive and/or cooling modules in a variety of configurations and additional modules may be added to best suit the product being processed. The advanced airflow system is developed using computer assisted guidance and analysis and includes ductwork that balances airflow more evenly over the product. The product is cooled intermittently during the dehydration process, allowing for a greater amount of IR radiation to be applied while reducing burning to the product and allowing for more moisture release.

The use of cooling modules in between the heating modules of the present invention allows for increased efficiency of IR dehydration and valuable volatile compound retention. Cooling can be achieved by drawing processed (temperature and humidity controlled) or ambient air through the dehydration cabinet. This, in turn has the capability of potentially increasing the efficiency of the entire drying line, which includes a secondary drying, freezing or vacuum process.

Computer assisted guidance and analysis programming is used to improve the detection performance of these quality indexes as well as other aspects. Furthermore, computer assisted guidance and analysis is used for process control by adjusting temperature, airspeed, and conveyance speed to keep the products on specification, which is especially helpful in adjusting for variable atmospheric conditions (e.g. relative humidity), the moisture and brix content of the material being dehydrated. The present invention further include automation and machine vision, as well known by those in the art.

To preserve product integrity while efficiently removing moisture, the system uses a plurality of sensors to achieve a thorough analysis of the requirements for maintaining the vitality of nutrient-rich compounds.

In cases where a compound would become significantly diluted in a dehydration process, the invention introduces ambient air into the system while hot. Depending on the requirements of the product or specimen, warm air can be exhausted through a separate vent or maintained. Regardless, the present invention enables controlled airflow provides optimal intensity of infrared for dehydration without risking burn. In cooling stations, the conveyance system delivers processed or ambient air onto the product, while vents exhaust hot or warm, moist air. Each cool air vent is designed for even airflow distribution, ensuring optimal dehydration conditions.

The modular dehydration system features an airflow system with a system processing unit, heating chamber with IR, and cooling chamber. A system processing unit serves as the central control hub, managing system operation with data from sensors mounted within the airflow system, enabling precise control and monitoring. Sensors, including conveyance system sensors and heat sensors, generate feedback data, facilitating real-time monitoring. This feedback is provided to an AI algorithm, which analyzes sensor data to predict optimal dehydration conditions, ensuring preservation of vital compounds. Furthermore, the system's use of IR radiation is beneficial for the reason it directly interacts with compound molecules, promoting expeditious energy transfers. The concentration in energy minimizes energy loss whereas the airflow system adequately dehydrates the specimen, allowing for safe, efficient, and even economic dehydration of products.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a cross sectional view of the present invention.

FIG. 2 is a rendering of the inner mechanism of the present invention.

FIG. 3 is a flow chart of the method of the present invention.

FIG. 4 depicts the modular dehydration system flow.

FIG. 5 illustrates the sensor training model of the present invention.

### DETAILED DESCRIPTION OF THE PREFERRED EMBODIMENT

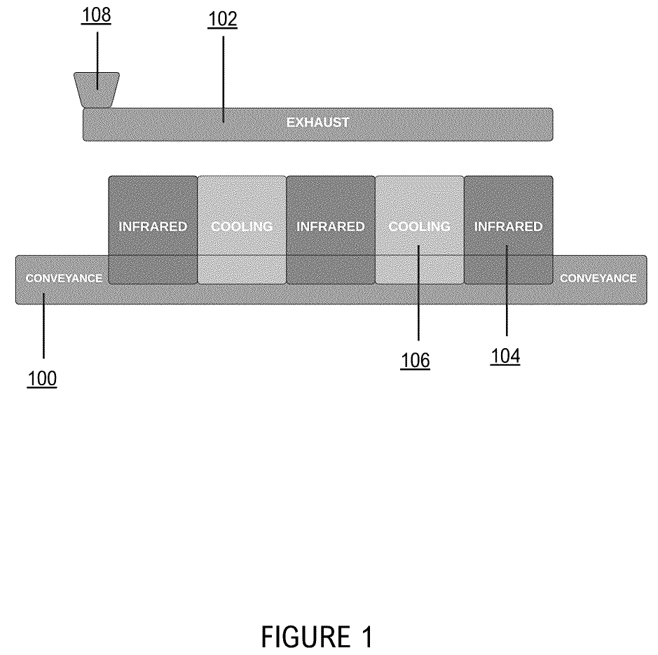

FIG. 1 is a cross sectional view of the present invention. In accordance with the preferred embodiment of the present invention, processed (temperature and humidity controlled) or ambient air is pushed into the system while hot or warm air is exhausted in a separate vent. This occurs while the product moves through the dehydration system 100. The influx of processed (temperature and humidity controlled) or ambient air allows the product to receive a higher intensity of IR for dehydration purposes without the risk of burning or altering the product. The duct 102 on the top of the system brings in the processed (temperature and humidity controlled) or ambient air, which is vented onto the product at each of the “cooling” stations labeled below. The central vent 108 exhausts the hot air and moisture to prevent the accumulation of heat and moisture within the system. Interspersed between each cooling station 104 is a heating station 106. This is where the product is exposed to the low to high intensity IR for dehydration.

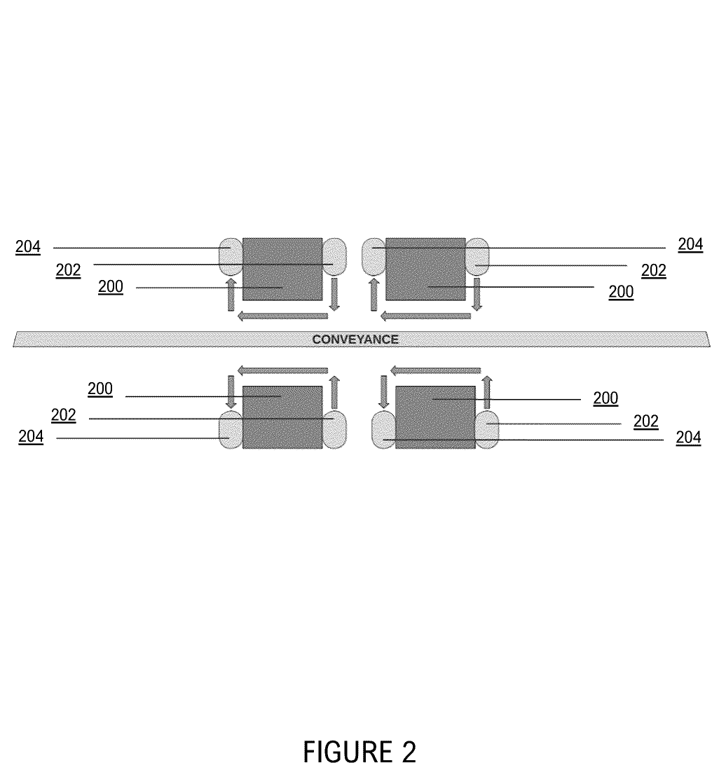

FIG. 2 is a rendering of the inner mechanism of the present invention. In accordance with the preferred embodiment of the present invention, the product is moved through the system on a conveyance system 200. The conveyance system located in the cooling stations are configured to provide processed (temperature and humidity controlled) or ambient air from the vents 202 onto the product from the cooling ducts 102 shown in FIG. 1. Hot or warm and moist air is then exhausted from the space via vents 204 located on each section of the conveyance 200 opposite of the processed (temperature and humidity controlled) or ambient air vents. Each cool air vent 202 contains an insert designed based on fluid dynamic analysis to ensure even distribution of airflow from the fan, through the ducts and out onto the material being dehydrated. This system of venting hot air and pushing in processed (temperature and humidity controlled) or ambient air allows for the product to receive a higher intensity of IR for dehydration purposes without burning or changing in composition.

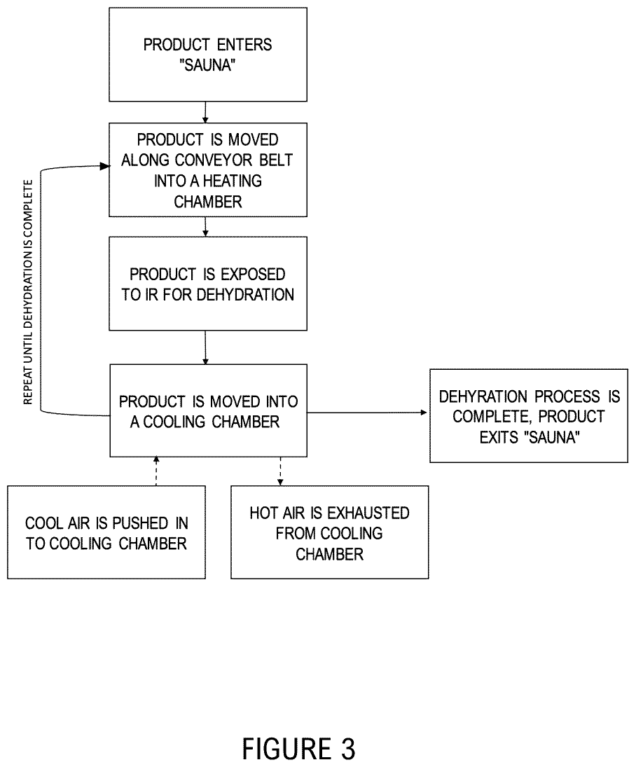

FIG. 3 is a flow chart of the method of the present invention. In accordance with the preferred embodiment of the present invention, a product that is to be dehydrated enters the system through a conveyance process. The first IR chamber exposes the product to IR for dehydration purposes. Following the first chamber, the product enters a second non IR chamber in which processed (temperature and humidity controlled) or ambient air is pushed in and hot or warm (and moisture laden) air is exhausted out via a system of ducts and vents. This prevents the surface temperature of the product from overheating and burning, which may cause damage. Once the product has cooled in the second chamber, it enters another IR chamber, and this process of alternating IR and cooling chambers is repeated along the path of the conveyance in accordance with the system and its specific design for the product that is being dehydrated. The system can be designed to have various numbers of cooling or IR chambers to achieve the desired dehydration level of a specific product. Once the product has reached the desired level of dehydration, it exits the system.

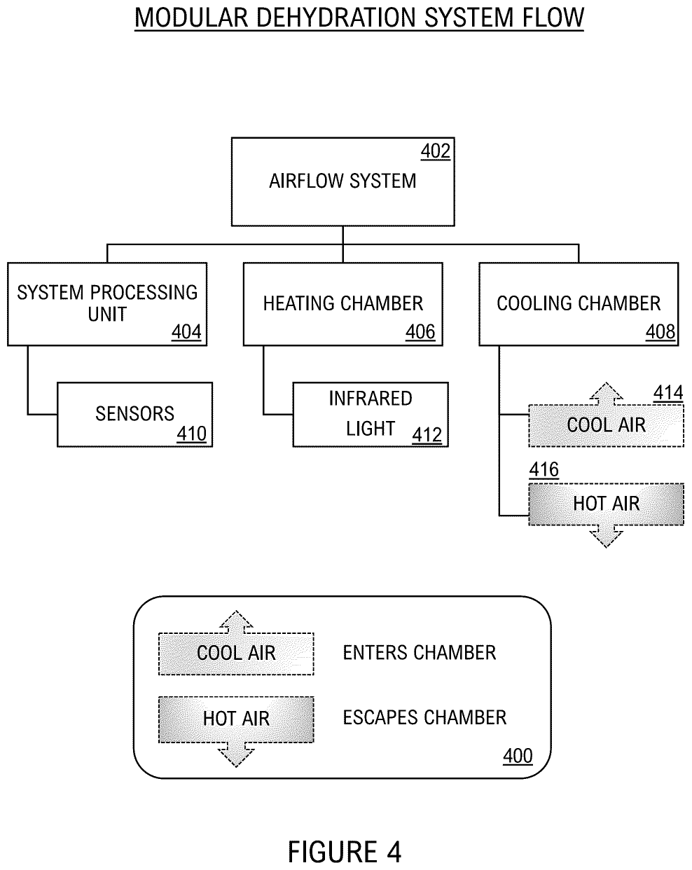

FIG. 4 depicts the modular dehydration system flow 400. The airflow system 402 which comprises of the system processing unit 404, a heating chamber 406 with infrared light 412 (IR), and a cooling chamber 408. The system processing unit 404 retrieves data from sensors 410 mounted within the airflow system 402. The cooling chamber 408 retrieves cool air 414 and enables it to enter while also allowing hot air 416 to escape the chamber.

The modular dehydration system flow 400, is designed to optimize the dehydration process. Within the airflow system 402, the system processing unit 404 serves as the central control hub, managing the operation of the system from various communication devices, Bluetooth enabled devices, network connections (i.e., WiFi, internet, hotspot), and digital displays/interfaces. Integrated within the airflow system are heating and cooling chambers: the heating chamber 406 equipped with infrared light 412 (IR) for dehydration, and the cooling chamber 408 for temperature control. Mounted sensors 410 within the airflow system provide real-time data to the system processing unit 404, enabling precise control and monitoring of dehydration conditions throughout the process.

The dehydration process begins with the product exposed to IR in the first chamber, initiating the moisture withdrawal process with precision. AI analyzes data acquired from the sensors 410 to predict optimal dehydration conditions for preserving volatile compounds or specific compounds the model is trained to preserve. Subsequently, the product transitions into a non-IR chamber, the cooling chamber 408 where processed or ambient air is introduced, while hot or warm, moistened air is exhausted via ducts and vents. This alternating choreography of IR and cooling chambers prevents the product surface from overheating, minimizing the risk of damage. As the product graduates along the conveyer belt's path, it undergoes multiple cycles of IR exposure and cooling. It should be noted that the system is custom tailored based on the dehydration requirements of the product in response to the specifications of the desired end result, and the data in which the machine learning model is trained on.

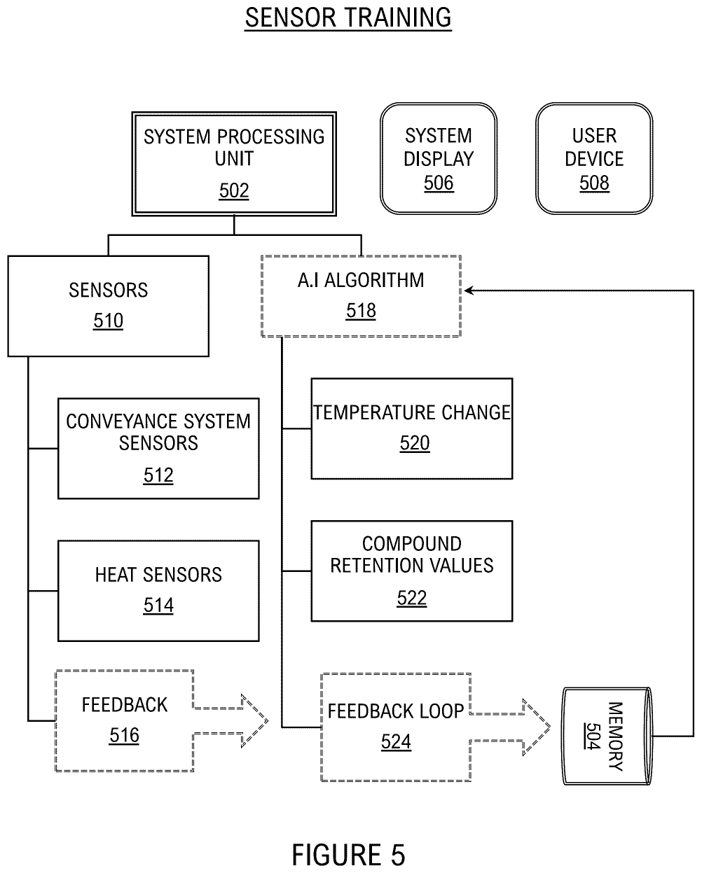

FIG. 5 illustrates the sensor training model of the present invention. Components delineated within two solid lines represent elements of the system processing unit 502, which incorporates memory 504. For clarity, memory 504 may encompass random access memory (RAM), as well as local and cloud variants. Serving as the central controller of the sensors, the system processing unit 502 facilitates the execution of functions performed by the AI algorithm 518, delineated within two dotted lines.

Sensors 510 in the modular dehydration system comprise of a plurality of sensor types and can be configured to receive sensor data from conveyance systems and other sensor systems both internally and externally. By way of example, and not limitation, the figure depicts conveyance system sensors 512 and heat sensors 514 which all generate sensor feedback 516 data. This data is used to manage and monitor conditions during the dehydration process. The heat sensor 514 captures temperature data at various points within the system and supplies real-time feedback on temperature levels on the system display 504 as well as a communication enabled user device 508.

Feedback 516 from sensors 510 are also provided to the A.I algorithm 518. The AI algorithm 518 is deployed to analyze the sensor data collected by both local and external sensors 510 configured to the system processing unit 502. The algorithm utilizes advanced machine learning techniques to process the data, identify patterns and effectuate the conditions necessary for a dehydration operation without sacrificing vital compounds in a bioactive specimen. This is executed using real-time data sources, such as bioactivity data from local sensors and research databases.

Once the target dehydration level is achieved, the end product should still comprise of the desired nutrients and compounds due to the system's adaptive control models use of dehydration parameters.

While various embodiments of the disclosed technology have been described above, it should be understood that they have been presented by way of example only, and not by limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A modular dehydration system with heating and cooling modules, the system comprising:
a temperature and humidity-controlled ducting system to introduce temperature-controlled and ambient air within said modular dehydration system;
a conveyance channel, configured to guide movement and transmit said ambient air using at least one air vent;
a central vent for exhausting hot air and excess heat and moisture; and
a system processing unit, configured to receive and transmit sensor data from a plurality of sensors corresponding to said conveyance channel and said temperature and humidity-controlled ducting system.

2. The modular dehydration system of claim 1, wherein said humidity-controlled ducting system has asymmetric and symmetric perforations.

3. The modular dehydration system of claim 2, wherein heat transfer efficiency is increased by said asymmetric and symmetric perforations in said humidity-controlled ducting system.

4. The modular dehydration system of claim 2, further comprising of said asymmetric and symmetric perforations in said humidity-controlled ducting system utilizing computer-assisted guided to achieve desired airflow patterns.

5. The modular dehydration system of claim 1, wherein airflow introduced into said at least one air vent is customized using parameters of bio-active product inputs.

6. The modular dehydration system of claim 1, further comprising of said system processing unit receiving real-time adjustments to airflow parameters using feedback from said plurality of sensors.

7. The modular dehydration system of claim 1, wherein volatile compound retention is maximized by controlling temperature and humidity levels during a dehydration operation.

8. A method for heating and cooling modules in a modular dehydration system, the method comprising:
monitoring and controlling a temperature within a temperature and humidity-controlled ducting system to introduce temperature-controlled and ambient air within said modular dehydration system;
introducing ambient air using at least one air vent in said modular dehydration system through a conveyance channel;
interposing a heating chamber between a cooling chamber;
exposing a specimen to said ambient air within said modular dehydration system using said heating chamber and said cooling chamber;
exhausting hot air and excess heat and moisture through at least one central vent; and
processing, receiving and transmitting sensor data from a plurality of sensors on said conveyance channel and said temperature and said humidity-controlled ducting system through a system processing unit.

9. The method of claim 8, wherein said humidity-controlled ducting system has asymmetric and symmetric perforations.

10. The method of claim 9, wherein heat transfer efficiency is increased by said asymmetric and symmetric perforations in said humidity-controlled ducting system.

11. The method of claim 9, further comprising of said asymmetric and symmetric perforations in said humidity-controlled ducting system utilizing computer-assisted guided to achieve desired airflow patterns.

12. The method of claim 8, wherein airflow introduced into said at least one air vent is customized using parameters of bio-active product inputs.

13. The method of claim 8, further comprising of said system processing unit receiving real-time adjustments to airflow parameters using feedback from said plurality of sensors.

14. The method of claim 8, wherein volatile compound retention is maximized by controlling temperature and humidity levels during a dehydration operation.

15. A modular dehydration system with heating and cooling modules, the system comprising:
a temperature and humidity-controlled ducting system to introduce temperature-controlled and ambient air within said modular dehydration system, and wherein said humidity-controlled ducting system has asymmetric and symmetric perforations for temperature transfer;
a conveyance channel, configured to guide movement and transmit said ambient air using at least one air vent, and wherein said conveyance channel uses said temperature and said humidity controlled ducting system to generate a desirable airflow pattern;
a central vent for exhausting hot air and excess heat and moisture; and
a system processing unit, configured to receive and transmit sensor data from a plurality of sensors corresponding to said conveyance channel and said temperature and said humidity-controlled ducting system.

16. The modular dehydration system of claim 15, further comprising of said temperature and said humidity-controlled ducting system utilizing bioactive data of a specimen or product undergoing a dehydration operation.

17. The modular dehydration system of claim 16, further comprising of said airflow introduced into said at least one air vent customized using parameters of bio-active product inputs.

18. The modular dehydration system of claim 15, further comprising of said system processing unit receiving real-time adjustments to airflow parameters using feedback from said plurality of sensors.

19. The modular dehydration system of claim 15, wherein volatile compound retention is maximized by controlling temperature and humidity levels during a dehydration operation.

20. The modular dehydration system of claim 15, wherein at least one heating chamber and at least one cooling chamber are disposed in proximity to said conveyance channel.
